(19) United States
(12) Patent Application Publication
(10) Pub. No.: US 2011/0268107 A1
(43) Pub. Date: Nov. 3, 2011

(54) Registry Proxy Server Apparatus, Communication System, and Operation Mode Changing Method

(76) Inventors: Motohisa Araki, Akishima-shi (JP); Takanori Kaji, Tokyo (JP)

(21) Appl. No.: 13/073,779

(22) Filed: Mar. 28, 2011

(30) Foreign Application Priority Data
Apr. 30, 2010 (JP) 2010-105619

(51) Int. Cl. H04L 12/66

(52) U.S. Cl. 370/352

(57) ABSTRACT

According to one embodiment, a registry proxy server apparatus includes a connector, a register controller, a monitor and a change controller. The connector connects a plurality of IP telephone servers registering a plurality of IP telephone terminals and including a normal mode and an ecology mode. The register controller determines an arbitrary IP telephone server and allows the determined server to perform registry a IP telephone terminal as request source. The monitor monitors respective operational states of the plurality of IP telephone terminals and the plurality of IP telephone servers. The change controller changes an operation mode of at least one of the plurality of IP telephone servers based on a monitoring result obtained by the monitor.

### CROSS-REFERENCE TO RELATED APPLICATIONS

This application is based upon and claims the benefit of priority from Japanese Patent Application No. 2010-105619, filed Apr. 30, 2010; the entire contents of which are incorporated herein by reference.

### FIELD

Embodiments described herein relate generally to a registry proxy server apparatus, a communication system, and an operation mode changing method that enable changing an operation mode of each communication apparatus to an ecology mode in, e.g., an Internet Protocol (IP) telephone system.

### BACKGROUND

In recent years, an IP telephone system that transmits or receives images or sound bi-directionally as packet data through an Internet protocol (IP) network in real time has begun to spread. In this IP telephone system, not only extension-to-extension communication or transmission/reception of outside calls can be carried out in accordance with each IP telephone server connected to the IP network but also the extension-to-extension communication or the transmission/reception of outside calls can be performed between the IP telephone servers through the IP network.

In this type of system, an IP terminal is registered in each IP telephone server on the IP network in advance, and the IP telephone server authenticates the IP terminal when making a call at the IP terminal via the IP network.

Meanwhile, in the IP telephone system constituted of the plurality of IP telephone servers, even when the number of users is small depending on a time zone or a date, all the servers are in service, and hence electric power is wastefully consumed.

It is to be noted that, as a conventional technology concerning this type, there has been suggested an information system consisting of a client, a server, and an administrative apparatus, the information system being configured to monitor whether the client and the server communicate with each other by using the administrative apparatus and to transmit to the server an operation mode switching request that instructs to switch an operation mode of the server to an ecology mode when no communication is performed. Further, as a relevant conventional technology, a server apparatus that dynamically changes an operation mode of an IP telephone terminal from a normal mode to an ecology mode has been suggested. Furthermore, another relevant conventional technology, a system that puts together respective pieces of processing of a network at night to reduce an operational cost has been also suggested.

However, in an IP telephone system constituted of a plurality of telephone servers, an implementation method of achieving power saving in the entire system in accordance with a use status has not been developed yet.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic block diagram showing a configuration of an IP telephone system according to this first embodiment;

FIG. 2 is a block diagram showing a functional configuration of a registry administrative server, a presence server, IP telephone servers, and an IP telephone terminal depicted in FIG. 1;

FIG. 3 is a view showing an example of stored contents in a terminal register state administrative table depicted in FIG. 2;

FIG. 4 is a view showing an example of stored contents in a server state administrative table depicted in FIG. 2;

FIG. 5 is a view showing an example of stored contents of a server configuration information table depicted in FIG. 2;

FIG. 6 is a view showing an example of stored contents in a server configuration setting data table depicted in FIG. 2;

FIG. 7 is a view showing an example of stored contents in a state administrative table depicted in FIG. 2;

FIG. 8 is a sequence diagram showing an operation of performing registry processing between the IP telephone terminal and the IP telephone server in the first embodiment;

FIG. 9 is a flowchart showing a control processing procedure of a registry proxy server when performing the registry processing between the IP telephone terminal and the IP telephone server in the first embodiment;

FIG. 10 is a sequence diagram showing an operation of performing registry destination change processing for the IP telephone server with respect to the IP telephone terminal in the first embodiment;

FIG. 11 is a flowchart showing an ecology mode transition control procedure of the registry proxy server when performing the registry destination change processing in the first embodiment;

FIG. 12 is a sequence diagram showing an operation of performing registry destination change processing for an IP telephone server with respect to an IP telephone terminal as this second embodiment; and

FIG. 13 is a flowchart showing a normal mode transmission control procedure of a registry proxy server when performing the registry destination change processing in the second embodiment.

### DETAILED DESCRIPTION

Various embodiments will be described hereinafter with reference to the accompanying drawings. In general, according to one embodiment, a registry proxy server apparatus comprising: a connector configured to connect a plurality of Internet Protocol (IP) telephone servers registering a plurality of IP telephone terminals and including a normal mode and an ecology mode; a register controller configured to determine an arbitrary IP telephone server and allow the determined server to perform registry a IP telephone terminal as request source, when a register request operation is carried out in the IP telephone terminal; a monitor configured to monitor respective operational states of the plurality of IP telephone terminals and the plurality of IP telephone servers; and a change controller configured to change an operation mode of at least one of the plurality of IP telephone servers based on a monitoring result obtained by the monitor.

### First Embodiment

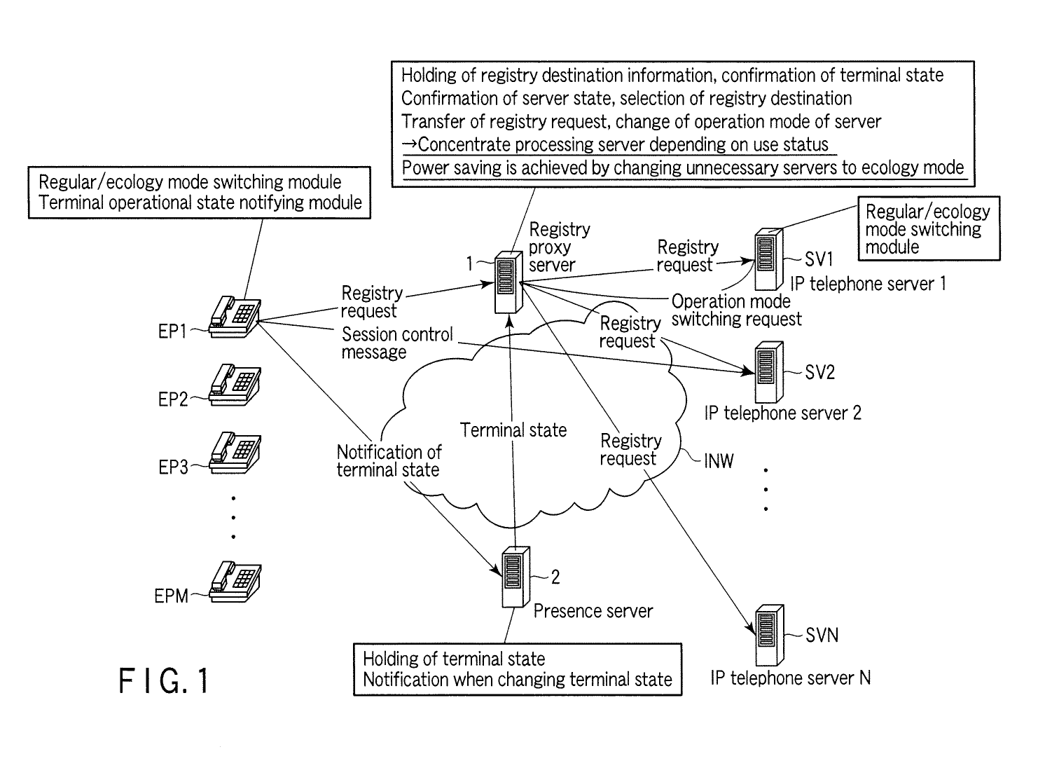

FIG. 1 is a schematic block diagram showing a configuration of an IP telephone system according to a first embodiment.

To an IP network INW are further connected IP telephone servers SV1 to SVN (N is a natural number) and IP telephone terminals EP1 to EPM (M is a natural number). The IP telephone servers SV1 to SVN have an exchange control function with respect to the IP telephone terminals EP1 to EPM as registry targets through the IP network INW.

Furthermore, to the IP network INW are connected a registry proxy server 1 that performs terminal registry from the IP telephone terminals EP1 to EPM to the IP telephone severs SV1 to SVN by proxy and a presence server 2 as a state administrative server.

The presence server 2 administers terminal states of the IP telephone terminals EP1 to EPM on the IP network INW.

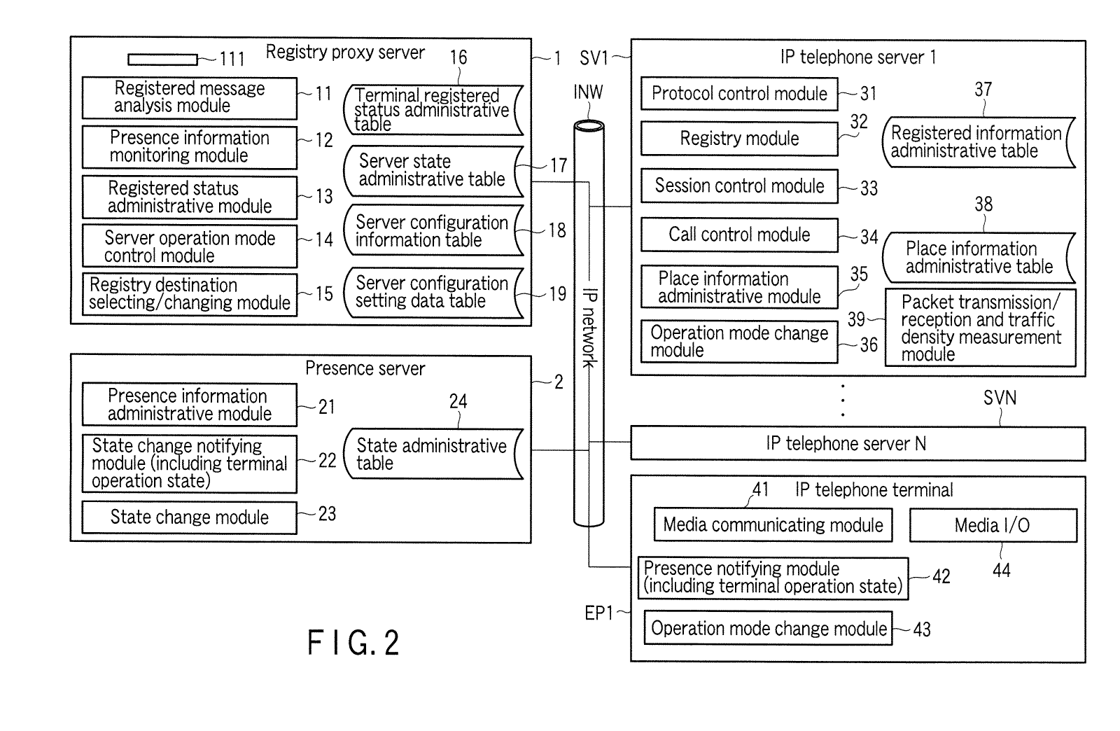

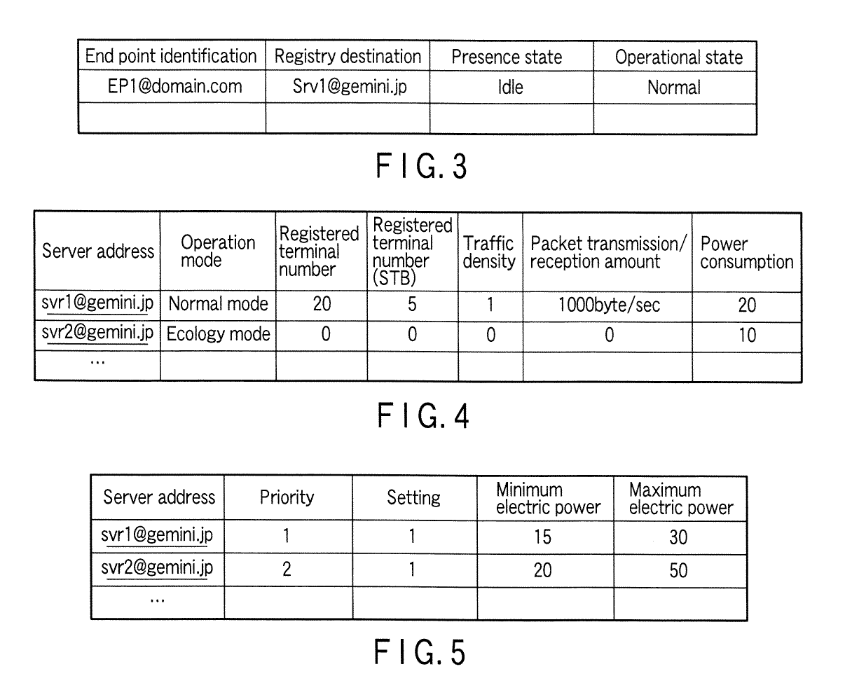

FIG. 2 shows a functional configuration of the registry proxy server 1, the presence server 2, the IP telephone servers SV1 to SVN, and the IP telephone terminals EP1 to EPM. It is to be noted that the IP telephone server SV1 and the IP telephone terminal EP1 will be explained as representatives in this example.

The registry proxy server 1 includes a registered message analysis module 11 (which will be referred to as an analysis module 11 hereinafter) as registry controller, a connecting module 111 of connecting the IP telephone servers SV1 to SVN, a presence information monitoring module 12 as monitor, a registered status administrative module 13 (which will be referred to as an administrative module 13 hereinafter), a server operation mode control module 14 (which will be referred to as a control module 14 hereinafter), a registry destination selecting/changing module 15 (which will be referred to as a selecting/changing module 15 hereinafter), a terminal registered status administrative table 16 (which will be referred to as an administrative table 16 hereinafter), a server state administrative table 17 (which will be referred to as an administrative table 17 hereinafter), a server configuration information table 18 (which will be referred to as an information table 18 hereinafter), and a server configuration setting data table 19 (which will be referred to as a data table 19 hereinafter). It is to be noted that the administrative module 13, the control module 14, and the selecting/changing module 15 constitute change controller.

Registry relationships between the IP telephone servers SV1 to SVN and the IP telephone terminals EP1 to EPM are associated with each other in the administrative table 16, and this table stores data indicative of correspondence relationships of end point identifiers (URIs) for identifying the IP telephone terminals EP1 to EPM, addresses of the IP telephone servers SV1 to SVN as registry destinations, presence states, and operational states.

The administrative table 17 stores states of the respective IP telephone servers SV1 to SVN, and it stores data indicative of correspondence relationships of addresses of the IP telephone servers SV1 to SVN, current operation modes, the number of the registered IP telephone terminals EP1 to EPM, the number of terminals utilizing a Set Top Box (STB) in the registered IP telephone terminals EP1 to EPM, traffic densities of the IP telephone servers SV1 to SVN, packet transmission/reception amounts of the IP telephone servers SV1 to SVN, and power consumption of the IP telephone servers SV1 to SVN. Here, the traffic density is a value indicative of the number of times that a communication path is established between the plurality of IP telephone terminals registered in the IP telephone servers per unit time. The packet transmission/reception amount is a value indicative of the number of RTP packets transmitted/received between the plurality of IP telephone terminals registered in the IP telephone servers per unit time. It is to be noted that the STB is used when registering an analog telephone set or a digital telephone set as an IP telephone terminal in the IP telephone servers SV1 to SVN.

The information table 18 is a table in which priorities assigned to the respective IP telephone servers SV1 to SVN are associated with electric power amounts that can be used in the respective IP telephone servers SV1 to SVN to be administered, and this table stores data indicative of correspondence relationships of addresses of the IP telephone servers SV1 to SVN, priorities, set IDs, minimum electric power amounts, and maximum electric power amounts as shown in FIG. 5. Here, the priority represents an order that is set in a normal mode, and it is arbitrarily set by, e.g., a maintenance person. Although described later in detail, the set ID is identifying information required to identify throughputs of the respective IP telephone servers SV1 to SVN to be set. Further, the set ID is identifying information that can be arbitrarily set by the maintenance person, and the minimum electric power amount is a minimum electric power amount required in each of the IP telephone servers SV1 to SVN and is an electric power amount determined to restrict the number of IP telephone terminals that are to be deregistered, for example. Furthermore, the maximum electric power amount is a maximum electric power amount required in each of the IP telephone servers SV1 to SVN, and it is an electric power amount determined to restrict the number of IP telephone terminals that are to be registered. The minimum electric power amount and the maximum electric power amount are amounts that are arbitrarily registered by the maintenance person in accordance with installation environments of the respective IP telephone servers SV1 to SVN.

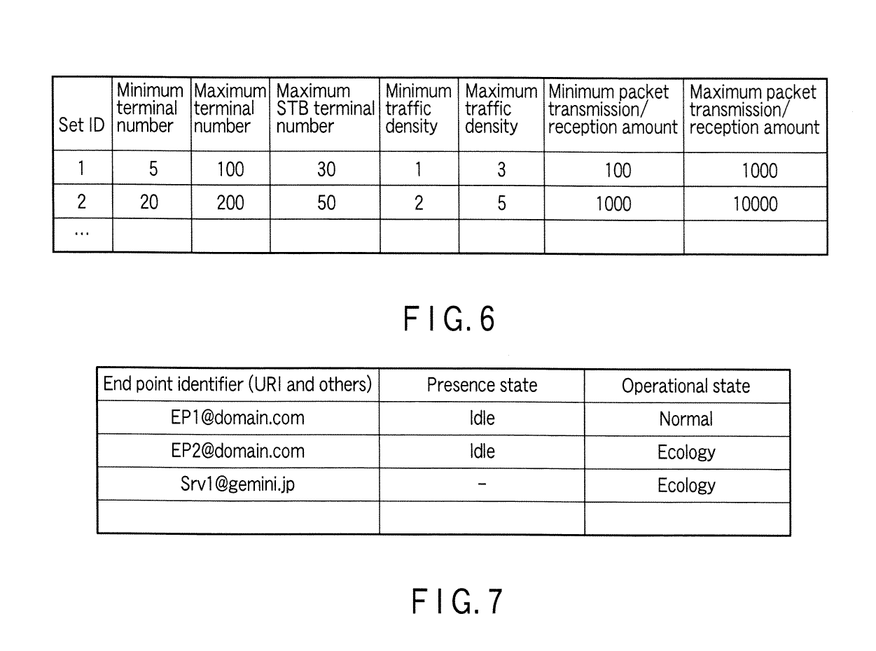

The data table 19 is a table configured to administer the set IDs registered in the information table 18, and it stores data indicative of correspondence relationships of installation IDs set and registered in the information table 18, registerable minimum terminal numbers, registerable maximum terminal numbers, maximum STB terminal numbers, minimum traffic densities, maximum traffic densities, minimum packet transmission/reception amounts, and maximum packet transmission/reception amounts as shown in FIG. 6.

The analysis module 11 is configured to analyze a registry request message received from each of the IP telephone terminals EP1 to EPM.

The monitoring module 12 is configured to carry out interface processing between the registry proxy server 1 and the presence server 2, and it acquires information concerning terminate states of the IP telephone terminals EP1 to EPM based on communication with the presence server 2 and updates the administrative table 16, the administrative table 17, and the information table 18.

The administrative module 13 is configured to make reference to the administrative table 16 and administer registered states of the IP telephone terminals EP1 to EPM based on this reference result. The control module 14 is configured to make reference to the administrative table 17, determine to change, e.g., the IP telephone server SV2 to the ecology mode when the registered terminal number of the IP telephone server SV2 is, e.g., 4 based on this reference result, and transmit a state change request to the IP telephone server SV2 to change the current mode to the ecology mode.

For example, when the analysis module 11 has analyzed the registry request message transmitted from the IP telephone terminal EP1, the selecting/changing module 15 makes reference to the information table 18 to determine the IP telephone serer SV1 including the minimum priority, further makes reference to the administrative table 17 in regard to the IP telephone server SV1, registers the IP telephone terminal EP1 as a request source in the administrative table 16 in association with the IP telephone server SV1 if an operation mode of the IP telephone server SV1 is the “normal mode” as a result of this reference, and transmits a registry request to the IP telephone server SV1 to register the IP telephone terminal EP1.

Furthermore, for example, when the IP telephone server SV1 as a registry destination of the IP telephone terminal EP1 has been changed to the “ecology mode”, the selecting/changing module 15 makes reference to the information table 18 to determine the IP telephone server SV2 having the subsequent priority, makes reference to the administrative table 17 in regard to the IP telephone server SV2, registers, e.g., the IP telephone terminal EP1 as a request source in the administrative table 16 in association with the IP telephone server SV2 if the operation mode of the IP telephone server SV2 is the “normal mode” as a result of this reference, and transmits a registry request to the IP telephone server SV2 to register the IP telephone terminal EP1.

The presence server 2 includes a presence information administrative module 21 (which will be referred to as an administrative module 21 hereinafter), a state change notifying module 22 (which will be referred to as a notifying module 22 hereinafter), a state change module 23, and a state administrative table 24.

The state administrative table 24 stores states of the respective IP telephone servers SV1 to SVN and the respective IP telephone terminals EP1 to EPM, and it stores data indicative of correspondence relationships of end point identifiers (URIs) for identifying the IP telephone terminals EP1 to EPM, addresses of the IP telephone servers SV1 to SVN, and presence states, and operational states.

The administrative module 21 constantly monitors the state administrative table 24. When the presence states and the operational states of the IP telephone terminals EP1 to EPM and the IP telephone servers SV1 to SVN registered and administered in the state administrative table 24 have been changed, the notifying module 22 notifies the registry proxy server 1 of a message about this change.

The state change module 23 monitors presence states and operational states of the IP telephone terminals EP1 to EPM and the IP telephone servers SV1 to SVN. If an operational defect has occurred in the IP telephone terminals EP1 to EMP and the IP telephone servers SV1 to SVN, this module changes an operational state associated with, e.g., the IP telephone terminal EP3 having the operational defect in the state administrative table 24 from “normal” to “abnormal”.

The IP telephone server SV1 includes a protocol control module 31, a registry module 32, a session control module 33, a call control module 34, a place information administrative module 35 (which will be referred to as an administrative module 35 hereinafter), an operation mode change module 36 (which will be referred to as a change module 36 hereinafter), a registered information administrative table 37 (which will be referred to as an administrative table 37 hereinafter), a place information administrative table 38 (which will be referred to as an administrative table 38 hereinafter), and a packet transmission/reception and traffic density measurement module 39 (which will be referred to as a measurement module 39 hereinafter).

For example, when the IP telephone terminals EP1 to EPM to be registered are associated with an SIP, the protocol control module 31 transmits/receives a message for effecting registry to/from the IP telephone terminals EP1 to EPM based on the SIP, and also transmits/receives a message for establishing a session with the IP telephone terminals EP1 to EPM. The registry module 32 registers the IP telephone terminal EP1 that has issued a registry request in the administrative table 37.

The session control module 33 establishes a session with the registered IP telephone terminal EP1 and transmits/receives, e.g., a response signal.

The call control module 34 executes call connection processing with the registered IP telephone terminal EP1.

The administrative module 35 associates phone numbers as terminal identifying information previously assigned to the registered IP telephone terminals EP1 to EPM, MAC (Media Access Control) as fixed network addresses, and IP addresses as variable network addresses with each other, and registers and administers them in the administrative table 38.

The change module 36 changes the normal mode/ecology mode in response to a mode change instruction from the registry proxy server 1.

The measurement module 39 measures a packet amount transmitted/received to/from the registered IP telephone terminals EP1 to EPM and a traffic density indicative of the number of times that a session is established with respect to the registered IP telephone terminals EP1 to EPM.

The IP telephone terminal EP1 includes a media communicating module 41, a presence notifying module 42, an operation mode change module 43 (which will be referred to as a change module 43 hereinafter), and a media I/O 44.

The media communicating module 41 performs communication of a media having, e.g., sound or video through the medial I/O 44. For example, it is assumed that, in the IP telephone terminal EP1, a user has performed a call operation. Then, the medial communicating module 41 transmits, e.g., an INVITE message specified by the SIP to the IP telephone server SV1 as a registry destination. It is to be noted that the INVITE message includes codec information such as G711 (sound), G729a (sound), G722 (sound), or H264 (video). When the IP telephone server SV1 transmits a response message including H264 (video) to the IP telephone terminal EP4 which is a reception side and a session using H264 is established with respect to the IP telephone terminal EP4, communication of RTP packets including video is executed with respect to the IP telephone terminal EP4 through the session.

The presence notifying module 42 notifies the presence server 2 of a presence state in a fixed cycle. Here, in case of the SIP, a REGISTER message is transmitted to the IP telephone server SV1 as a registry destination in a fixed cycle. In response to transmission of this REGISTER message, ACK is received from the IP telephone server SV1, and then OPTION for making an inquiry about the presence state is received from the IP telephone server SV1. The presence notifying module 42 interposes information indicative of the presence state in the SDP in a response message (NOTICE) for OPTION and transmits this message to the IP telephone server SV1.

The change module 43 changes the normal mode/ecology mode in accordance with a mode change instruction from the registry proxy server 1.

An operation of the thus configured system will now be described.

For example, to concentrate processing in the IP telephone server SV1, a module of enabling selecting the IP telephone server SV1 desired by the system side as a registry destination of the respective IP telephone terminals EP1 to EPM is required. In a general IP telephone protocol, it is common to select the registry destination based on settings on the terminal side. However, in this embodiment, this setting is realized by preparing the registry proxy server 1 that is configured to grasp an operational state of the system by using a scheme of presence and change the registry destination in accordance with this state so that the registry destination can be determined by the intent of the system side.

Examples of data required for distribution of registry of the registry proxy server 1 are the terminal registered state administrative table 16, the server state administrative table 17, the server configuration information table 18, and the server configuration setting data table 19. In these examples, the terminal registered state administrative table 16, the server state administrative table 17, and the server configuration information table 18 are updated when transmitting a registry message in notification of a state change from the presence server 2 and registry of the IP telephone terminal.

When registry request messages have been received from the IP telephone terminals EP1 to EPM, the registry proxy server 1 makes reference to the information in the administrative table 16, the administrative table 17, the information table 18, and the data table 19, selects, e.g., the IP telephone server SV3 that has the minimum priority “1” and is operating in the normal mode, and transmits a message.

### (State Administration of IP Telephone Server)

An operation when changing the IP telephone server SV1 from the “normal mode” to the “ecology mode” will now be described.

The registry proxy server 1 refers to the administrative table 17. If any one of the terminal registered number, the STB terminal registered number, the traffic density, and the packet transmission/reception amount is lower than a predetermined value, the registry proxy server 1 transmits a request to change the mode to the ecology mode to the IP telephone server SV1 and transmits a message indicative of the state change to the presence server 2. This message includes information indicative of the IP telephone server SV1 and information indicative of the change from the “normal mode” to the “ecology mode”.

When the presence server 2 is notified of the state of the IP telephone server SV1, it updates administrative information of itself and notifies the registry proxy server 1 of the state change of the IP telephone server SV1.

Upon receiving the notification about the state change of the IP telephone server SV1, the registry proxy server 1 updates registered contents of the server state administrative table 17. Carrying out such operations enables the registry proxy server 1 to effect the state administration of the IP telephone servers SV1 to SVN in the IP telephone system.

### (Distribution System of Terminal Registry Signal)

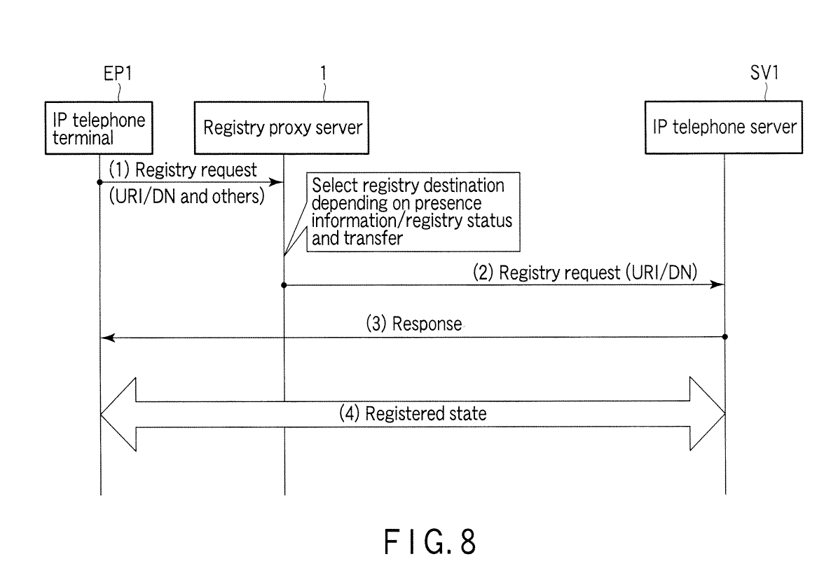

FIG. 8 is a sequence diagram showing an operation of performing the registry processing between the IP telephone terminal EP1 and the IP telephone server SV1.

When registering the IP telephone terminal EP1 with respect to the IP telephone servers SV1 to SVN, a user of the IP telephone terminal EP1 performs a call operation specifying the registry proxy server 1. Then, the IP telephone terminal EP1 generates a registry request for the registry proxy server 1, transmits this request to the IP network INW (FIG. 8(1)), and calls the registry proxy server 1 as a receiver. Further, when the registry proxy server 1 responds to this incoming call, a communication link is formed between the IP telephone terminal EP1 and the registry proxy server 1.

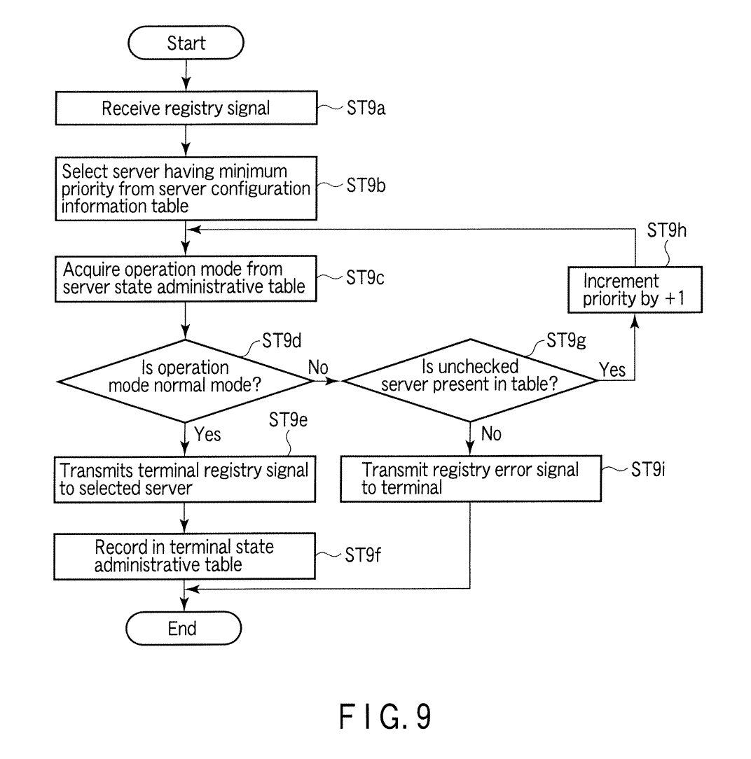

Furthermore, the registry proxy server 1 executes a control processing procedure depicted in FIG. 9.

First, the registry proxy server 1 refers to the information table 18 to select an IP telephone server including the minimum priority. In this example, the IP telephone sever SV1 corresponding to the priority “1” is selected. Moreover, the registry proxy server 1 refers to the administrative table 17 (a block ST9c) and determines whether an operation mode associated with the IP telephone server SV1 is the “normal mode” (a block ST9d).

In this example, since the operation mode associated with the IP telephone server SV1 is the “normal mode” (Yes), the registry proxy server 1 advances to a block ST9e and notifies the selected IP telephone server SV1 of a registry request including information of the terminal side (URI/DN/address/port and others) (FIG. 8(2)).

When the IP telephone server SV1 responds to the notification about this registry request (FIG. 8(3)), a session is established between the IP telephone server SV1 and the IP telephone terminal EP1. Moreover, an URI and others of the IP telephone terminal EP1 are registered in the administrative table 37 of the IP telephone server SV1 (FIG. 8(4)).

Thereafter, the registry proxy server 1 registers information in which the IP telephone server SV1 is associated with the IP telephone terminal EP1 in the administrative table 16 (a block ST9f).

On the other hand, at the block ST9d, when the operation mode associated with the IP telephone server SV1 is the “ecology mode” (No), the registry proxy server 1 determines whether any other IP telephone server registered in the information table 18 is present (a block ST9g). Here, if another IP telephone server is present (Yes), the registry proxy server 1 increments the priority from “1” to “2” (a block ST9h). Additionally, it acquires the operation mode from the administrative table 17 in relation to the IP telephone server SV2 associated with the priority “2” and determines whether the operation mode is the “normal mode”. That is, the processing of the block ST9c and the block ST9d is repeatedly executed with respect to all the IP telephone servers SV2 to SVN registered in the administrative table 17 and the information table 18.

On the other hand, unchecked IP telephone servers are not present (No), the registry proxy server 1 transmits a registry error signal to the IP telephone terminal EP1 (a block ST9i).

### (Ecology Mode Transition System of IP Telephone Server)

Since a purpose of this embodiment is power saving, terminals and server operation modes are added as information administered by the presence server 2. If a state has been changed, a changed device notifies the presence server 2, and each device that relies on the presence server 2 about notification of changes is informed of the state change.

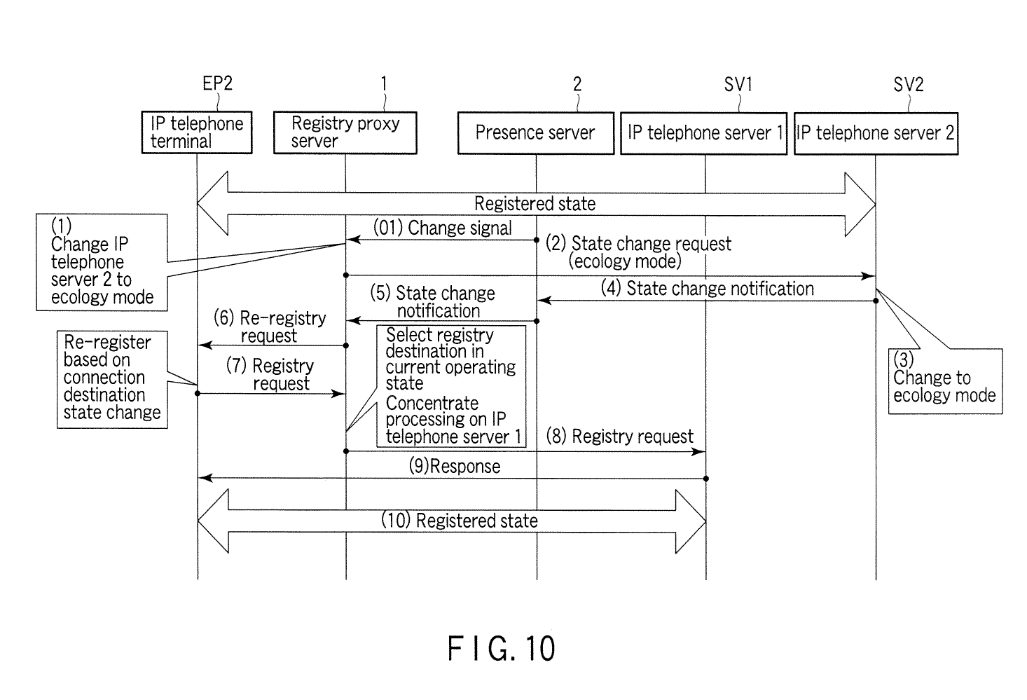

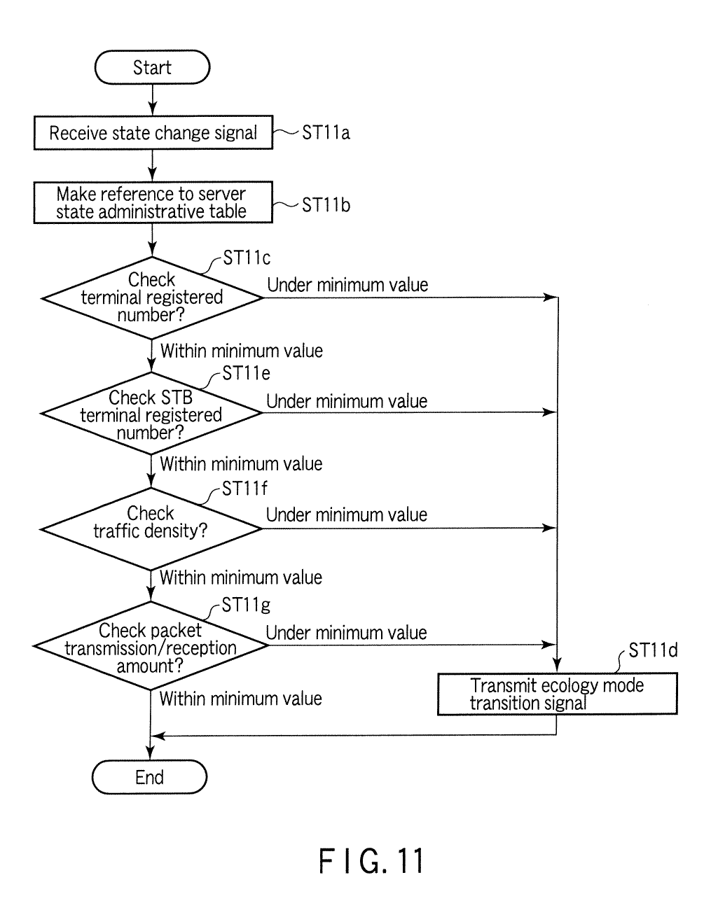

FIG. 10 is a sequence diagram showing an operation of performing registry destination change processing between the IP telephone terminal EP2 and the IP telephone server SV2. FIG. 11 is a flowchart showing an ecology mode transition control procedure of the registry proxy server 1 when executing the registry destination change processing.

The registry proxy server 1 grasps an operational state of each device based on information transmitted from the presence server 2 and concentrates/distributes registry destinations of the IP telephone terminals EP1 to EPM based on the administrative table 17 and the information table 18. Power saving of the entire system is achieved by intentionally changing the IP telephone server SV2 that does not have to be operated to the ecology mode from the grasped operational states of the entire system.

That is, upon receiving a change signal of a state of each of the IP telephone servers SV1 to SVN from the presence server 2 (a block ST11a), the registry proxy server 1 refers to the administrative table 17 (a block ST11b) and checks whether the number of the IP telephone terminals EP1 to EPM registered in the administrative table 17 is not greater than “5”, for example (a block ST11c). Here, if the registered terminal number of the IP telephone server SV2 is 4, changing the IP telephone server SV2 to the ecology mode is determined (FIG. 10(1)), and the processing advances to a block ST11d to transmit a state change request to the IP telephone server SV2, thereby changing the IP telephone server SV2 to the ecology mode (FIG. 10(2)).

Moreover, when the IP telephone server SV2 is changed from the normal mode to the ecology mode (FIG. 10(3)), the presence server 2 is notified of this state change (FIG. 10(4)).

Upon receiving the state change notification, the presence server 2 notifies the registry proxy server 1 of the state change (FIG. 10(5)).

The registry proxy server 1 notifies the IP telephone terminal EP2 registered in the IP telephone server SV2 of a re-registry request (FIG. 10(6)).

When registering the IP telephone terminal EP2 in response to the notification of the re-registry request from the registry proxy server 1, a user of the IP telephone terminal EP2 performs a call operation specifying the registry proxy server 1. Then, the IP telephone terminal EP1 generates a registry request for the registry proxy server 1 and transmits this request to the IP network INW (FIG. 10(7)).

Additionally, upon receiving the registry request, the registry proxy server 1 forms a communication link between the IP telephone terminal EP1 and the registered proxy server 1.

The registry proxy server 1 refers to the administrative table 17 and the information table 18, selects the IP telephone server SV1 based on this reference result, and notifies this IP telephone server SV1 of a registry request including information (URI/DN/address/port and others) of the terminal side (FIG. 10(8)).

When the IP telephone server SV1 responds to the notification about this registry request (FIG. 10(9)), a session is established between the IP telephone server SV1 and the IP telephone terminal EP2, and an URI and others of the IP telephone terminal EP2 are registered in the administrative table 37 of the IP telephone server SV1 (FIG. 10(10)).

Thereafter, the registry proxy server 1 registers information in which the IP telephone server SV1 is associated with the IP telephone terminal EP2 in the administrative table 16 and updates the registered contents in the administrative table 17. In this case, the operation mode associated with the IP telephone server SV2 in the administrative table 17 is updated from the “normal mode” to the “ecology mode” and the registered terminal number, the STB registered terminal number, the traffic density, and the packet transmission/reception amount are also updated.

Additionally, if the registered terminal number of the IP telephone server SV2 is 5 at the block ST11c, the registry proxy server 1 checks whether the number of the registered STB terminals is not greater than, e.g., “2” (a block ST11e). Here, if the STB terminal registered number of the IP telephone server SV2 is 1, changing the IP telephone server SV2 to the ecology mode is determined, and the processing advances to a block ST11d to transmit a state change request to the IP telephone server SV2, thereby changing the IP telephone server SV2 to the ecology mode.

Further, if the STB registered terminal number of the IP telephone server SV2 is “2” at the block ST11e, the registry proxy server 1 checks whether the traffic density of the IP telephone server SV2 registered in the administrative table 17 is not greater than “2” (a block ST11f). Here, for example, if the traffic density of the IP telephone server SV2 is “1”, changing the IP telephone server SV2 to the ecology mode is determined, and the processing advances to a block ST11d where a state change request is transmitted to the IP telephone server SV2 to change its operation mode to the ecology mode.

Furthermore, if the traffic density of the IP telephone server SV2 is not greater than “2” at the block ST11f, the registry proxy server 1 checks whether the packet transmission/reception amount of the IP telephone server SV2 registered in the administrative table 17 is not greater than “500” (a block ST11g). Here, if the packet transmission/reception amount of the IP telephone server SV2 is, e.g., “400”, changing the IP telephone server SV2 to the ecology mode is determined, and the processing advances to the block ST11d where a state change request is transmitted to the IP telephone server SV2 to change its operation mode to the ecology mode.

On the other hand, if the packet transmission/reception amount of the IP telephone server SV2 is not greater than “500” at the block ST11g, the registry proxy server 1 terminates the processing as it is.

It is to be noted that the above-described processing is repeatedly executed with respect to all the IP telephone servers SV1 to SVN registered in the administrative table 17 and the information table 18.

As described above, in the first embodiment, the registry proxy server 1 refers to the server state administrative table 17, the server configuration information table 18, and the server configuration setting data table 19 to check the terminal registered numbers and the STB terminal registered numbers in the IP telephone servers SV1 to SVN, the traffic densities of the IP telephone servers SV1 to SVN, the packet transmission/reception amounts as registered items in the server state administrative table 17 and the server configuration information table 18, thereby efficiently determining the IP telephone servers SV1 to SVN to change the operation mode to the ecology mode.

As a result, when the system is not heavily used, the IP telephone server SV2 that does not have to operate can be created by the intent of the system, and changing this IP telephone server SV2 to the ecology mode enables reducing power consumption of the entire system.

Furthermore, in the first embodiment, when the presence server 2 extended to enable monitoring operating states of the terminals cooperates with the registry proxy server 1, registry statuses of the terminals, connection statuses of the servers, and operation statuses of the terminals can be easily grasped. When the system is not heavily used, the IP telephone server SV2 that does not have to operate can be created by the intent of the system based on these pieces of information, and changing this IP telephone server SV2 to the ecology mode enables reducing power consumption of the entire system.

Moreover, the registry destinations of the IP telephone terminals EP1 to EPM can be concentrated based on settings of the system side, thereby facilitating maintenance when effecting intensive maintenance is desired, e.g., when updating firmware of all the IP telephone terminals EP1 to EPM in the system is desired.

### Second Embodiment

In a second embodiment, the IP telephone server that has been changed to the ecology mode in the first embodiment is reset to the normal mode. According to the second embodiment, all IP telephone servers SV1 to SVN in a server state administrative table 17 can be prevented from being changed to the ecology mode.

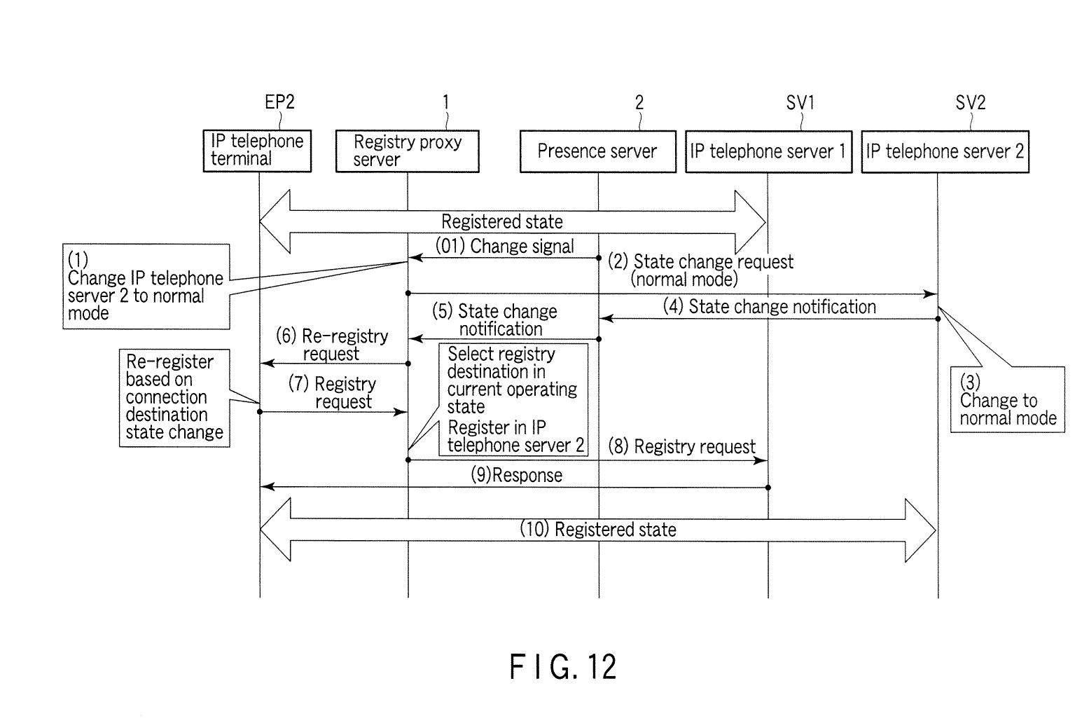

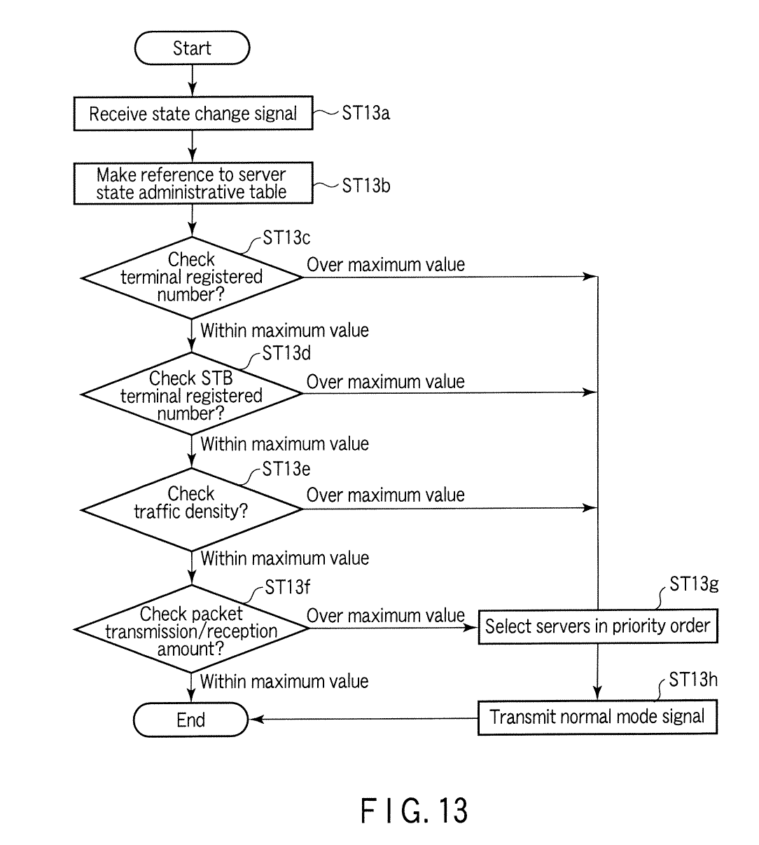

FIG. 12 is a sequence diagram showing an operation of performing registry destination change processing between an IP telephone terminal EP2 and IP telephone servers SV1 and SV2 as the second embodiment according to the present invention. FIG. 13 is a flowchart showing a normal mode transition control procedure of a registry proxy server 1 when executing the registry destination change processing.

In a presence server 2, a change signal used for resetting the IP telephone server SV2 which has been changed to the ecology mode, to the normal mode is transmitted to the registry proxy server 1 (FIG. 12(01)). As a timing for resetting to the normal mode, for example, “a normal mode change start time is set in advance” or “a standby time of the IP telephone server changed to the ecology mode is counted in advance, and a normal mode change request is transmitted to the IP telephone server that has reached a fixed time” can be considered.

Here, as a method of setting the normal mode change start time in advance, for example, 13:00 in the daytime that is a reoperation time of the system is set in advance. Further, as a method of counting a standby time of the IP telephone server that has been changed to the ecology mode, for example, after a normal mode change request is transmitted to the IP telephone server after elapse of two hours from transition of the IP telephone server to the ecology mode.

When the registry proxy server 1 receives the change signal concerning states of the IP telephone servers SV1 to SVN from the presence server 2 (a block ST13a), it refers to an administrative table 17 (a block ST13b). Further, it determines whether the number of IP telephone terminals EP1 to EPM registered in the administrative table 17 exceeds, e.g., “3” (a block ST13c). Here, if the number of the registered terminals is “2”, the registry proxy server 1 determines whether the number of registered STB terminals exceeds, e.g., “2” (a block ST13d).

Here, if the number of the registered terminals is “1”, the registry proxy server 1 determines whether a traffic density exceeds “1” (a block ST13e). Here, if the traffic density is “0”, the registry proxy server 1 determines whether a packet transmission/reception amount exceeds “200” (a block ST13f). Here, if the packet transmission/reception amount is “100”, the registry proxy server 1 maintains the ecology mode states of the IP telephone servers SV1 to SVN as they are.

On the other hand, for example, if the number of the registered IP telephone terminals EP1 to EPM with respect to the IP telephone server SV2 is, e.g., “4” at the block ST13c, the registry proxy server 1 advances to a block ST13g to determine changing the IP telephone server SV2 to the normal mode (FIG. 12(1)) and further advances to a block ST13h where it transmits a state change request to change the IP telephone server SV2 to the normal mode (FIG. 12(2)).

Moreover, for example, if the number of the registered STB terminals with respect to the IP telephone server SV3 is, e.g., “3” at the block ST13d, the registry proxy server 1 determines to change the IP telephone server SV3 to the normal mode and transmits a state change request to change the IP telephone server SV3 to the normal mode.

Additionally, for example, if the traffic density of the IP telephone server SV4 is, e.g., “2” at the block ST13e, the registry proxy server 1 determines to change the IP telephone server SV4 to the normal mode and transmits a state change request to the IP telephone server SV4 to change its mode to the normal mode.

Further, for example, if the packet transmission/reception amount of the IP telephone server SV5 is, e.g., “300” at the block ST13f, the registry proxy server 1 determines to change the IP telephone server SV5 to the normal mode and transmits a state change request to the IP telephone server SV5 to change its mode to the normal mode.

It is to be noted that, as the number of the registered IP telephone terminals EP1 to EPM, the number of registered terminals that are not re-registered in any other IP telephone server when changing the IP telephone server SV2 to the ecology mode can be considered, for example. The number of the registered STB terminals is the same as the number of the registered IP telephone terminals EP1 to EPM. Furthermore, threshold values of the traffic density and the packet transmission/reception amount are determined to be values set by a maintenance person.

Moreover, when the IP telephone server SV2 is changed from the ecology mode to the normal mode (FIG. 12(3)), it notifies the presence server 2 of this state change (FIG. 12(4)).

Upon receiving the state change notification, the presence server 2 notifies the registry proxy server 1 of the state change (FIG. 12(5)).

The registry proxy server 1 notifies the IP telephone terminal EP2 registered in the IP telephone server SV1 of a re-registry request (FIG. 12(6)).

When registering the IP telephone terminal EP2 in response to the notification of the re-registry request from the registry proxy server 1, a user of the IP telephone terminal EP2 performs a call operation specifying the registry proxy server 1. Then, the IP telephone terminal EP1 generates a registry request for the registry proxy server 1 and transmits this request to the IP network INW (FIG. 12(7)).

Further, when the registry proxy server 1 receives the registry request, it forms a communication link between the IP telephone terminal EP1 and the registry proxy server 1.

The registry proxy server 1 notifies the IP telephone server SV2 of a registry request including information of the terminal side (URI/DN/address/port and others) (FIG. 12(8)).

When the IP telephone server SV2 responds to the notification of this registry request (FIG. 12(9)), a session is established between the IP telephone server SV2 and the IP telephone terminal EP2, and an URI and others of the IP telephone terminal EP2 are registered in an administrative table 37 of the IP telephone server SV2 (FIG. 12(10)).

Thereafter, the registry proxy server 1 registers information in which the IP telephone server SV2 is associated with the IP telephone terminal EP2 in a terminal registry status administrative table 16 and updates registered contents in the server state administrative table 17. In this case, the operation mode associated with the IP telephone server SV2 in the serve state administrative table 17 is updated to the “normal mode” from the “ecology mode” and also updates the number of registered terminals, the number of registered STB terminals, a traffic density, and a packet transmission/reception amount as required.

As described above, according to the second embodiment, the IP telephone server SV2 which has been changed to the ecology mode, can be prevented from staying in the ecology mode for a long period of time, thereby enabling an efficient operation while suppressing power consumption of the entire system.

### Other Embodiments

For example, in each of the foregoing embodiments, the configuration that the plurality of IP telephone servers are distributed on the network has been exemplified, but a conformation that the plurality of IP telephone terminals are connected to one IP telephone server which is a representative of the plurality of IP telephone servers can be also considered. Furthermore, it can be also considered that a judgment on switching a registry destination is made based on not only the ecology mode but also the regular presence state. For example, when the number of the registered IP telephone terminals in the IP telephone server in the normal mode has exceeded a predetermined number, changing the registry destination to any other IP telephone server in the normal mode can be considered. Moreover, when an operational defect has occurred in the IP telephone server in the normal mode, changing the registry destination to any other IP telephone server in the normal mode can be considered.

Additionally, although the configuration that the registry proxy server 1 is operated in the independent device is adopted, a configuration that this module is operated in the same device as a different server, e.g., the IP telephone server can be considered.

Further, in each of the foregoing embodiments, besides the method of referring to the number of the registered terminals or the traffic density of each server and transmitting a mode transition signal, the registry proxy server may check power consumption of each server, make a judgment to minimize power consumption of the system, and transmit the mode transition signal.

Besides, the configuration of the communication system, the functional configuration of the registry proxy server, the operation mode change procedure, the change procedure for the registry destination of the IP telephone terminal, and others may be modified and carried out in many ways without departing from the gist.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A registry proxy server apparatus comprising:
a connector configured to connect a plurality of Internet Protocol (IP) telephone servers registering a plurality of IP telephone terminals and including a normal mode and an ecology mode;
a register controller configured to determine an arbitrary IP telephone server and allow the determined server to perform registry a IP telephone terminal as request source, when a register request operation is carried out in the IP telephone terminal;
a monitor configured to monitor respective operational states of the plurality of IP telephone terminals and the plurality of IP telephone servers; and
a change controller configured to change an operation mode of at least one of the plurality of IP telephone servers based on a monitoring result obtained by the monitor.

2. The apparatus of claim 1, wherein the change controller notifies the plurality of IP telephone terminals registered in a first IP telephone server by the register controller of the change, when changing the first IP telephone server to the ecology mode, dynamically changes a registry destination of the IP telephone terminal being performed a register request operation from the first IP telephone server to a second IP telephone server in response to the notification, and dynamically changes the empty first IP telephone server from the normal mode to the ecology mode.

3. The apparatus of claim 1, wherein the monitor monitors at least one of the number of registered IP telephone terminals registered in each IP telephone server, the number of IP telephone terminals in the ecology mode, a traffic density of each IP telephone server, a packet throughput of each IP telephone server, and power consumption of each IP telephone server.

4. The apparatus of claim 3, further comprising a memory configured to store an administrative table in which server identifying information for identifying each IP telephone server, a current operation mode, the number of the registered IP telephone terminals registered in each IP telephone server, a traffic density of each IP telephone server, a packet throughput of each IP telephone server, and power consumption of each IP telephone server are associated with each other,
the monitor refers to the administrative table and monitors an operational state of each of the plurality of IP telephone terminals and the plurality of IP telephone servers based on a result of this reference, and
the change controller dynamically changes the registry destination of the IP telephone terminals from the first IP telephone server to the second IP telephone server, dynamically changes the empty first IP telephone server from the normal mode to the ecology mode, and then updates stored contents in the administrative table.

5. The apparatus of claim 4, wherein the registry controller refers to the administrative table stored in the memory, when a registry request operation is performed in the IP telephone terminal, determines an arbitrary first IP telephone server based on a result of the reference, and allows the determined server to perform the registry the IP telephone terminal as request source.

6. The apparatus of claim 2, wherein the monitor comprises an interface configured to achieve connection with a state proxy server capable of disclosing, updating, and notifying of states of the IP telephone terminals and the IP telephone servers, and
when changing the first IP telephone server to the ecology mode based on information transmitted/received with respect to the state proxy server through the interface, the change controller notifies the plurality of IP telephone terminals registered in the first IP telephone server by the registry controller of the change, dynamically changes the registry destination of the IP telephone terminal being performed a registry request operation from the first IP telephone server to a second IP telephone server in response to the notification, and dynamically changes the empty first IP telephone server from the normal mode to the ecology mode.

7. The apparatus of claim 2, wherein the change controller changes the first IP telephone server being the ecology mode, to the normal mode based on a monitoring result obtained by the monitor, notifies the plurality of IP telephone terminals registered in the second IP telephone server of the change, and dynamically changes the registry destination of the IP telephone terminal being performed a registry request operation from the second IP telephone server to the first IP telephone server in response to the notification.

8. A communication system comprising:
a plurality of Internet Protocol (IP) telephone servers configured to register a plurality of IP telephone terminals and include a normal mode and an ecology mode; and
a registry proxy server apparatus connected to the plurality of IP telephone servers through a communication network,
wherein the registry proxy server apparatus comprises:
a registry controller configured to determine an arbitrary IP telephone server and allow the determined server to perform the registry the IP telephone terminal as request source when a registry request operation is performed in the IP telephone terminal;
a monitor configured to monitor respective operational states of the plurality of IP telephone terminals and the plurality of IP telephone servers; and
a change controller configured to change an operation mode of at least one of the plurality of IP telephone servers based on a monitoring result obtained by the monitor.

9. The system of claim 8, wherein the change controller notifies the plurality of IP telephone terminals registered in a first IP telephone server by the register controller of the change, when changing the first IP telephone server to the ecology mode, dynamically changes a registry destination of the IP telephone terminal being performed a register request operation from the first IP telephone server to a second IP telephone server in response to the notification, and dynamically changes the empty first IP telephone server from the normal mode to the ecology mode.

10. The system of claim 8, wherein the monitor monitors at least one of the number of registered IP telephone terminals registered in each IP telephone server, the number of IP telephone terminals in the ecology mode, a traffic density of each IP telephone server, a packet throughput of each IP telephone server, and power consumption of each IP telephone server.

11. The system of claim 10, further comprising a memory configured to store an administrative table in which server identifying information for identifying each IP telephone server, a current operation mode, the number of the registered IP telephone terminals registered in each IP telephone server, a traffic density of each IP telephone server, a packet throughput of each IP telephone server, and power consumption of each IP telephone server are associated with each other,
the monitor refers to the administrative table and monitors an operational state of each of the plurality of IP telephone terminals and the plurality of IP telephone servers based on a result of this reference, and
the change controller dynamically changes the registry destination of the IP telephone terminals from the first IP telephone server to the second IP telephone server, dynamically changes the empty first IP telephone server from the normal mode to the ecology mode, and then updates stored contents in the administrative table.

12. The system of claim 11, wherein the registry controller refers to the administrative table stored in the memory, when a registry request operation is performed in the IP telephone terminal, determines an arbitrary first IP telephone server based on a result of the reference, and allows the determined server to perform the registry the IP telephone terminal as request source.

13. The system of claim 9, wherein the change controller changes the first IP telephone server being the ecology mode, to the normal mode based on a monitoring result obtained by the monitor, notifies the plurality of IP telephone terminals registered in the second IP telephone server of the change, and dynamically changes the registry destination of the IP telephone terminal being performed a registry request operation from the second IP telephone server to the first IP telephone server in response to the notification.

14. An operation mode changing method that is used by a registry proxy server apparatus configured to connect a plurality of Internet Protocol (IP) telephone servers registering a plurality of IP telephone terminals and including a normal mode and an ecology mode,
the method comprising:
determining an arbitrary first IP telephone server and allowing the determined server to perform the registry the IP telephone terminal as request source when a registry request operation is performed in the IP telephone terminal;
monitoring respective operational states of the plurality of IP telephone terminals and the plurality of IP telephone servers;
notifying the plurality of IP telephone terminals registered in the first IP telephone server of a change when changing the first IP telephone server to the ecology mode based on a result of the monitoring, and dynamically changing a registry destination of the IP telephone terminal being performed the registry request operation from the first IP telephone server to a second IP telephone server in response to the notification; and
dynamically changing the empty first IP telephone server from the normal mode to the ecology mode.

15. The method of claim 14, wherein the monitoring includes monitoring at least one of the number of registered IP telephone terminals registered in each IP telephone server, the number of IP telephone terminals in the ecology mode, a traffic density of each IP telephone server, a packet throughput of each IP telephone server, and power consumption of each IP telephone server.

16. The method of claim 15, further comprising storing an administrative table in which server identifying information for identifying each IP telephone server, a current operation mode, the number of the registered IP telephone terminals registered in each IP telephone server, a traffic density of each IP telephone server, a packet throughput of each IP telephone server, and power consumption of each IP telephone server are associated with each other,
the monitoring includes referring to the administrative table and monitoring an operational state of each of the plurality of IP telephone terminals and the plurality of IP telephone servers based on a result of this reference, and
the changing includes changing the registry destination of the IP telephone terminals from the first IP telephone server to the second IP telephone server, dynamically changing the empty first IP telephone server from the normal mode to the ecology mode, and then updating stored contents in the administrative table.

17. The method of claim 16, wherein the notifying includes referring to the administrative table, when a registry request operation is performed in the IP telephone terminal, determining an arbitrary first IP telephone server based on a result of the reference, and allowing the determined server to perform the registry the IP telephone terminal as request source.

18. The method of claim 14, further comprises an interface configured to achieve connection with a state proxy server capable of disclosing, updating, and notifying of states of the IP telephone terminals and the IP telephone servers, and
when changing the first IP telephone server to the ecology mode based on information transmitted/received with respect to the state proxy server through the interface, the changing includes notifying the plurality of IP telephone terminals registered in the first IP telephone server of the change, dynamically changing the registry destination of the IP telephone terminal being performed a registry request operation from the first IP telephone server to a second IP telephone server in response to the notification, and dynamically changing the empty first IP telephone server from the normal mode to the ecology mode.

19. The method of claim 14, wherein the changing includes changing the first IP telephone server being the ecology mode, to the normal mode based on a monitoring result, notifying the plurality of IP telephone terminals registered in the second IP telephone server of the change, and dynamically changing the registry destination of the IP telephone terminal being performed a registry request operation from the second IP telephone server to the first IP telephone server in response to the notification.
